(19) United States
(12) Patent Application Publication
(10) Pub. No.: US 2022/0182300 A1
(43) Pub. Date: Jun. 9, 2022

(54) NETWORK SYSTEM OPERATING WITH PREDICTED EVENTS

(71) Applicant: SIGNIFY HOLDING B.V., EINDHOVEN (NL)

(72) Inventors: WALTER JEROEN SLEGERS, EINDHOVEN (NL); JUDOCUS NICOLAAS PULLES, HAPERT (NL)

(21) Appl. No.: 17/602,666

(22) PCT Filed: Apr. 16, 2020
(86) PCT No.: PCT/EP2020/060735

§ 371 Date: Oct. 8, 2021

(30) Foreign Application Priority Data
Apr. 17, 2019 (EP) 19169767.1

(51) Int. Cl. H04L 43/067; H04L 43/065; H04L 43/028; H04L 41/22

(52) U.S. Cl. CPC H04L 43/067; H04L 41/22; H04L 43/028; H04L 43/065

(57) ABSTRACT

The present invention relates to reducing data traffic in network systems (100). An event representing a change in a sending system (10) which follows a previous event is detected by an event detector (14). Furthermore an event following the previous event is predicted by predictors (18, 34) in the sending system (10) and a receiving system (12) based on the previous event. The detected and predicted event are compared by a comparer (20) in the sending system (10). The detected event is send from the sending system (10) to the receiving system (12) only if the detected and predicted event are not equal. For ensuring use of correct events, the predicted event in the receiving system (12) is replaced with the detected event if the detected event is received by the receiving system (12) as in this case the prediction was not correct.

### FIELD OF THE INVENTION

The present invention relates to a network system, a method for operating the network system, a computer program product for performing the method for operating the network system, and a computer readable medium storing the computer program product.

### BACKGROUND OF THE INVENTION

US 2015/254570 A1 shows systems and methods for probabilistic semantic sensing in a sensory network. The system receives raw sensor data from a plurality of sensors and generates semantic data including sensed events. The system analyzes aggregations of semantic data with a probabilistic engine to produce a corresponding plurality of derived events each of which includes a derived probability. The system generates a first derived event, including a first derived probability, that is generated based on a plurality of probabilities that respectively represent a confidence of an associated semantic datum to enable at least one application to perform a service based on the plurality of derived events.

### SUMMARY OF THE INVENTION

It can be seen as an object of the present invention to provide a network system, a method for operating the network system, a computer program product for performing the method for operating the network system, and a computer readable medium storing the computer program product which allow operating a network system with reduced data traffic while keeping the responsiveness.

In a first aspect of the present invention a network system is presented. The network system comprises a sending system and a receiving system. The sending system includes an event detector, a predictor, and a comparer. The receiving system includes a predictor and a replacer. The event detector is configured for detecting changes in the sending system as events. The sending system is configured for transmitting the events. The receiving system is configured for receiving the events. The predictors are configured for predicting one or more events, i.e., one or more predicted events, following one or more previous events based on the one or more previous events. The comparer is configured for comparing one or more events detected by the event detector, i.e., one or more detected events, following the one or more previous events with the one or more predicted events predicted by the predictor of the sending system. The sending system is configured for transmitting the one or more detected events to the receiving system only if the one or more detected events and the one or more predicted events predicted by the predictor of the sending system are not equal. The replacer is configured for replacing the one or more predicted events predicted by the predictor of the receiving system with the one or more detected events if the one or more detected events are received by the receiving system.

The one or more previous events can be one or more events previously detected by the event detector. One or more events detected by the event detector following the one or more previous events become the one or more previous events for one or more further events following them at a later point in time and are used by the predictor for predicting the one or more further events.

Transmitting changes in the sending system as events within the network system only when an event occurs instead of regularly requesting and sending a status of the sending system allows to reduce the data traffic, cost, and communication bandwidth without deteriorating responsiveness. Since the sending system and the receiving system both include a predictor and as the sending system is configured for transmitting the one or more detected events to the receiving system only if it or they are not equal to the one or more predicted events predicted by the predictor of the sending system, data traffic, cost and required communication bandwidth for sending events can be reduced. Since the predictors of the sending system and the receiving system predict the same events, no event needs to be transmitted if the predicted events and the detected events are equal. Hence, instead of transmitting each event, only a limited number of events need to be transmitted, namely those events that are not correctly predicted by the predictors of the sending system and the receiving system.

The sending system can include a sender or a transceiver. Alternatively the sending system can include a sender and a receiver. The sender or the transceiver of the sending system can be configured for sending the events. The receiving system can include a receiver or a transceiver. Alternatively the receiving system can include a receiver and a sender. The receiver or transceiver of the receiving system can be configured for receiving the events.

The network system can be a connected lighting (CL) system, a heating ventilation air conditioning (HVAC) system, a home automation system, a building management system, a direct light control system, any other type of network system, or a combination thereof. The sending system can include one or more functional devices, such as luminaires, HVAC devices, switches, sensors, or the like.

Changes in the sending system can for example include a functional device being added to the sending system, a functional device being replaced by another functional device, a functional device being removed from the sending system, a functional device being deactivated, or a functional device being activated, such as a luminaire being activated, a sensor being activated, or a switch being switched. Adding, replacing, and removing a functional device to the sending system changes the configuration of the sending system, such that different functions can be performed by the sending system, e.g., adding a sensor to the sending system allows measuring a property and adding a luminaire allows providing light at the location of the luminaire, e.g. in a certain room. Activating a functional device, can include more than one event, e.g., activating a luminaire can include turning the status of the luminaire from deactivated to activated, changing a brightness level from 0% to 50%, changing the color, and changing the color temperature of the luminaire. The same information can also be included in a single event, e.g., activating the luminaire with brightness level 50% at a specific color and color temperature corresponding to a preconfigured event, e.g. as part of a lighting scene. Changes in the sending system can also for example include changes in the environment of the sending system, e.g., sunrise, sunset, or any other change in brightness of the environment of the sending system, e.g., caused by weather. Sunrise, sunset, and any other change in brightness of the environment can be detected by a brightness sensor. Alternatively or additionally, sunrise, sunset, and any other change in brightness of the environment of the sending system can be determined based on the geolocation of the sending system. For example, sunrise and sunset can be determined based on the current time at the geolocation of the sending system and other changes in brightness of the environment can be determined based on weather information at the geolocation. Changes in the sending system can furthermore for example include activating a preconfigured setting for luminaires in a room, such as a lighting scene including color, color temperature and/or brightness of one or more luminaires, or activating a preconfigured setting of one or more HVAC devices, such as preconfigured temperatures for different rooms or areas. A lighting scene corresponds to a set of preconfigured light states, e.g., preconfigured color, color temperature, and brightness of luminaires in the room. Changes in the environment of the sending system can also include changes in temperature or humidity in the environment of the sending system, e.g., caused by weather.

The receiving system can for example be a cloud server, a personal computer (pc), a remote control, a mobile phone, a tablet pc, or any other receiving system.

The receiving system can for example store the events for later analysis or forward the events to other services, such as if this than then (IFTTT), e.g. for offering cloud based home automation. The receiving system can also use the events in a mobile app for user control or monitoring. The receiving system can also use the events for out-of-home usage.

The comparer can be configured for generating one or more detected events which include no changes if there is no detected event to be compared to one or more predicted events. Alternatively or additionally, the sending system can be configured for generating control signals which cause one or more predicted events to be removed by the replacer when the control signals are received by the receiving system. The sending system can be configured for sending the control signals which cause one or more predicted events to be removed by the replacer to the receiving system if there is no detected event to be compared to one or more predicted events. This allows removing events that were not detected, but incorrectly predicted.

The sending system and the receiving system can each comprise a database for storing data about functional devices of the sending system. The sending system and the receiving system can include a computer readable medium, e.g., a memory. The database of the sending system and the database of the receiving system can be included in the respective computer readable medium. The predictor of the sending system can be configured for predicting the one or more events based on the one or more previous events and the data about the functional devices stored in the database of the sending system. The predictor of the receiving system can be configured for predicting the one or more events based on the one or more previous events and the data about the functional devices stored in the database of the receiving system. Since the predictors predict the one or more events based on the one or more previous events and the data stored in the respective database of the sending system and the receiving system, the prediction can be improved and the probability of correct predictions of events can be increased. Hence, the data traffic, cost, and communication bandwidth can be further reduced. This allows compression of the data to be transmitted from the sending system to the receiving system, as only a limited amount of events needs to be transmitted.

The data about functional devices can be synchronized between the sending system and the receiving system by sending the data from the sending system to the receiving system.

The data about functional devices can include data about a configuration of functional devices of the sending system and/or data about the environment of the functional devices of the sending system.

The data about the configuration of the functional devices can include a number and position of the functional devices, e.g., the number and position of the functional devices in different rooms. Storing the number and position of the functional devices in a certain room for example in case of a CL system allows to determine which lighting scenes are available for that room. The data about the configuration of the functional devices can include the structure of the functional devices, i.e., which functional device is arranged at which position and with which other functional devices the functional device forms a group of functional devices, e.g., a group of functional devices in a room. The groups of functional devices can be organized in rooms, floors, house areas, houses, or other hierarchical placement units.

A user can for example add functional devices in form of luminaires to the room and the information can be stored as data about the configuration of the functional devices. The user can then select a lighting scene, e.g., “relax”, “concentrate”, or “sunset”, which each include colors, color temperatures, and brightnesses for the luminaires in the room. Changing the lighting scene can be detected as event. Furthermore the changes of the parameters of the luminaires including brightness, color, and color temperature can be detected as events. The changes of the parameters can be predicted based on the change of the lighting scene. Therefore, only the change of the lighting scene needs to be send from the sending system to the receiving system, while the other changes can be correctly predicted by the predictors based on the previous event of changing the lighting scene in the room. When the user adds another luminaire to the room, the configuration is changed and this change is detected as event and the event can be stored in the databases. When the lighting scene is changed for the room after adding the additional luminaire, the change of color, color temperature, and brightness of the additional luminaire can also be predicted based on the previous event of changing the lighting scene. Equivalently when a luminaire is removed from the room, the information in the databases can be updated accordingly. When the lighting scene is changed for the CL system with removed luminaire, predicted events following the change of the lighting scene can be predicted accordingly. The lighting scene can also for example be applied to the luminaires of more than one room, such as the luminaires of a floor, to more than the luminaires of one floor, or to the luminaires of a whole house instead of only to the luminaires of one certain room. The functional devices can be arranged according to a hierarchy, e.g., single functional devices, functional devices associated to a room, functional devices associated to a floor, functional devices associated to a house, or according to any other hierarchy.

The data about the configuration of the functional devices can also include settings of one or more of the functional devices, e.g., a preconfigured or current brightness, color, color temperature, temperature, and/or humidity. The preconfigured settings can include an information in which cases a respective setting is activated, e.g., a preconfigured setting can be activated at a certain time, temperature, brightness, and/or humidity. The preconfigured settings can also for example include an event that a specific lighting scene is activated in a specific room when a specific button, e.g. on a user interface, is pressed. The pressing of the specific button event can be detected by and send from the sending system to the receiving system. Both systems can predict the following events based on this previous event of pressing the specific button. The pressing of a specific button can also lead to different events in dependence of time, e.g., at a first time the pressing of the specific button can lead to an activation of a first lighting scene in a room, while at another time it leads to the activation of a second lighting scene in the room.

The data about the environment of the functional devices of the sending system can include geolocation, weather information, time information, humidity information, brightness information, or any other information about the environment of the functional devices. The time information can for example be combined with the geolocation in order to determine the sunset time and sunrise time at the location of the functional devices.

The data about the functional devices stored in the databases can be used for providing a context for the one or more previous events received at the predictors and for predicting the one or more events based on the one or more previous events. For example if it is late night, i.e., typically sleeping time, the predictor may predict an event following a previous event of a motion being detected, to be adjusting a brightness of a luminaire to low brightness, while at evening the predictor may predict the predicted event to be adjusting the brightness of the luminaire to high brightness. This allows to automatically adjust the brightness for different contexts, e.g. high brightness for working in the evening and low brightness at late night in order to avoid glaring light that blinds the eyes.

The initial data about the functional devices stored in the databases is preferentially identical for both databases. This allows to ensure that both predictors predict the one or more events based on identical data. The data about the functional devices can also be synchronized in order to ensure that both predictors predict the one or more events based on identical data.

Both databases can be configured for updating the stored data based on events received by the databases. The events can for example include adding, removing, or replacing one or more functional devices from the sending system, i.e. changing the configuration of functional devices of the sending system. This allows to account for dynamic changes in the configuration of the functional devices and in the environment of the functional devices. By storing events in the databases, also typical behaviors of the users of the network system can be determined, such that the system can learn the behaviors of the users in order to improve the predictions of the events. For example, the databases can store information about typical usage patterns of the sending system, e.g. a typical luminaire activation pattern of a user, e.g., activating a luminaire in the sleeping room, being detected by the motion sensor in the sleeping room and subsequently in the bathroom, and activating a luminaire in the bathroom. The predictors can use this information when one or more events are detected after another. Additionally or alternatively the predictors can also use the contexts of the events, such as the time, e.g., when it is early morning the probability for the user to perform a typical morning routine luminaire activation pattern is higher than a typical bed time routine luminaire deactivation pattern. This allows an improved prediction of the events and thus reduces data traffic, cost, and required communication bandwidth.

The sending system can be configured for providing detected events from the event detector to the database of the sending system. The receiving system can be configured for providing identical events to the database of the receiving system such that both databases store the same information. The events received by the database of the receiving system are identical to the detected events as they are either identical to the events predicted by the predictor of the receiving system or as they are replaced by the detected events received by the transceiver of the receiving system if the predicted events are not identical. This allows to ensure that the predictors use identical information for predicting the events.

The predictors can be configured for predicting the one or more events by determining probabilities of different events and by selecting the events with a probability above a threshold probability as the predicted events or by selecting the event with the highest probability of the different events as the predicted event. The probabilities of the events can depend on the context of the one or more previous events, i.e., if a functional device was activated in a certain context, e.g., at a certain time. The probabilities of the events following the one or more previous events can be different for different context, e.g., different times. This allows to determine the events that have a probability above the threshold probability or the event that has the highest probability of a number of possible events, in particular in different contexts. Selecting events above a threshold probability as predicted events allows to reduce the number of incorrectly predicted events. This allows to reduce the data traffic, as less detected events including no changes or control signals which cause one or more predicted events to be removed by the replacer have to be send for removing events that have not been detected but incorrectly predicted.

The predictors can be configured for only selecting an event as predicted event when it has a probability above a threshold probability. The threshold probability can for example be 50%, 60%, 70%, 80%, or 90%. This allows to reduce the data traffic, as incorrectly predicted events can be reduced.

The predictors can be configured for determining a probability of an event based on the data about the functional devices of the sending system. The data about the functional devices can be data about the configuration of the functional devices. Preferably, the data about the configuration of the functional devices includes a number and position of one or more functional devices in a room, e.g., that certain luminaires and certain sensors are in the same room.

The predictors can be configured for determining a probability of an event based on a reachability of one or more functional devices of the sending system. The reachability of one or more functional devices can be stored as data about the functional devices in the databases and provided to the predictors for predicting the event. This allows to improve the prediction of the event. The reachability can be determined as a previous event.

The predictors can be configured for determining a probability of an event based on the data about the functional devices of the sending system. The data about the functional devices can be data about the configuration of the functional devices. Preferably, the data about the configuration of the functional devices includes a number and position of one or more functional devices in a room, e.g., that certain luminaires and certain sensors are in the same room.

The network system can comprise a user interface for allowing a user to interact with the network system. The user interface can be included in the sending system or in the receiving system. The network system can be configured for providing the user interface with the events. The user interface can include a display for providing information to the user. This allows to provide the user with the status of the network system via the user interface based on the events. The user interface can also include an input device, e.g., a keyboard, a mouse, buttons, or any other type of input device. Alternatively, the user interface can also be a combined display and input device, such as a touch display. The network system can also include two or more user interfaces. One or more of the user interfaces can be included in the sending system and one or more of the user interfaces can be included in the receiving system. The user interface can be configured for generating user commands, e.g., based on user inputs.

The network system can comprise a control unit configured for controlling the sending system. The control unit can be included in the sending system, e.g., in a bridge of the sending system. The control unit can be configured for generating control signals. The control signals can be used for controlling the sending system. The control unit can be configured for generating the control signals based on user commands or based on events received by the control unit. The control unit can be configured to run a computer program product that generates control signals based on user commands and/or based on events received by the control unit. The control unit allows controlling the sending system and in particular the functional devices of the sending system. The network system can also include more than one control units. One of the control units can be included in the receiving system. The control unit of the receiving system can be configured for generating control signals. The receiving system can be configured for providing the control signals to the sending system. The control signals can be used for controlling the receiving system and/or the sending system. The receiving system can be configured for providing the control signals to the sending system. The sending system can be configured for providing the control signals to one or more functional devices of the sending system. The control unit can allow controlling the functional devices of the sending system using the receiving system. Hence, beside local control of the functional devices via the sending system, remote control via the receiving system can be enabled.

The network system can be a connected lighting system. The sending system can include at least one functional device including one or more of: a luminaire, a switch, and a sensor. The connected lighting system comprises a control unit included in the sending system for controlling the at least one functional device. The connected lighting system can comprise a bridge, such as a Hue bridge. The control unit can be included in the bridge, e.g., the Hue bridge. Alternatively the network system can be a building management system, a home automation system, a HVAC system, a direct light control system, or any other type of network system. The sending system can include one or more luminaires, sensors, and/or switches. Alternatively or additionally the sending system can include one or more HVAC devices. A HVAC device can comprise an air conditioning device, a cooling device, and/or a heating device. The luminaire can be configured for providing light. The sensor can be configured for measuring one or more properties, e.g., environmental properties. The sensor can for example be a motion sensor, a brightness sensor, a humidity sensor, a temperature sensor, or any other kind of sensor. The switch can be configured for activating the bridge. Alternatively or additionally the switch can be configured for activating another functional device, such as a luminaire, a HVAC device, or any other functional device. The HVAC device can be configured for controlling a temperature, an airflow, and/or humidity in a room.

The event detector can be configured for detecting one or more events based on sensor data received from one or more functional devices of the sending system. The event detector can be configured for detecting the one or more events by analyzing the sensor data. Alternatively or additionally the event detector can be configured for detecting one or more events based on information data received from one or more of the functional devices of the sending system. Information data can also be received from the receiving system or another source. This allows to automatically generate events based on analyzing the sensor data and/or information data in the event detector.

The events can include a time stamp in order to allow the comparer to compare predicted events with detected events occurring at the same time and in order to allow the replacer to replace predicted events with detected events occurring at the same time. The event detector can be configured for providing the detected events with time stamps. The predictors can be configured for providing the predicted events with time stamps. This allows to ensure that the correct events are compared and replaced, e.g., when one or more events are received out of order during processing or transmitting. Using timestamps allows to notice when events are out of order and to reorder the events.

In a further aspect of the present invention a method for operating the network system according to claim 1 or any embodiment of the network system is presented. The method comprises the steps:

detecting by the event detector one or more changes in the sending system as one or more events following one or more previous events,

predicting by the predictors one or more events following the one or more previous events based on the one or more previous events,

comparing by the comparer the one or more detected events to the one or more predicted events predicted by the predictor of the sending system,

sending the one or more detected events from the sending system to the receiving system only if the one or more detected events and the one or more predicted events predicted by the predictor of the sending system are not equal,

replacing by the replacer the one or more predicted events predicted by the predictor of the receiving system with the one or more detected events if the one or more detected events are received by the receiving system.

The one or more previous events can be one or more events previously detected by the event detector. If the replacer does not replace the one or more predicted events predicted by the predictor of the receiving system with the one or more detected events, the predictor predicts one or more further events based on the one or more predicted events predicted by the predictor. In the other case, the predictor predicts one or more further events based on the one or more events detected by the event detector. This allows to reduce the amount of data traffic between the sending system and the receiving system, as detected events are not transmitted in cases in which the predicted events and the detected events are equal. Instead the predicted events can be used for further processing, including a prediction of further events based on the predicted events.

The method can include a step of providing the one or more events following the one or more previous events to the predictor of the sending system and the comparer in order for the predictor and comparer to process the events. The one or more events can be detected by the event detector by analyzing sensor data received from one or more functional devices of the sending system. The one or more events can alternatively or additionally be detected by the event detector by analyzing received information data. The information data can for example be received from the functional devices and/or the receiving system and/or another source, such as a server. The method can include a step of providing by the comparer the one or more detected events to the sending system only if the one or more detected events and the one or more predicted events are not equal. The method can include a step of providing the one or more detected events to the replacer of the receiving system only if the one or more detected events and the one or more predicted events are not equal.

The method can comprise the step:

receiving by the predictors data about functional devices of the sending system. The step of predicting by the predictors one or more events following the one or more previous events can be performed based on the one or more previous events and the received data about the functional devices.

The sending system and the receiving system can comprise a database for storing data about the functional devices of the sending system. The database can be included in a computer readable medium such as a memory. The data about the functional devices stored in the databases of the sending system and the receiving system can be provided to the predictors. The data about the functional devices can include data about a configuration of the functional devices of the sending system and/or data about the environment of the functional devices of the sending system. Predicting the events based on the one or more previous events and the data stored in the respective database of the sending system and the receiving system can improve the prediction and the probability of correct predictions of events can be increased. Hence, the data traffic, cost, and required communication bandwidth can be further reduced. This allows compression of the data to be send from the sending system to the receiving system, as only a limited amount of events needs to be send.

The method can include a step of updating the stored data about the functional devices based on events received by the databases.

The method can include a step of providing detected events from the event detector to the database of the sending system and identical events to the database of the receiving system such that both databases store the same information.

The method can include a step of predicting the one or more events by determining probabilities of different events and by selecting the events with a probability above a threshold probability as the predicted events or by selecting the event with the highest probability of the different events as the predicted event.

The method can include a step of determining a probability of an event based on the data about the functional devices.

The method can include a step of determining a probability of an event based on a reachability of one or more functional devices of the sending system.

The method can include a step of providing events to a user interface of the receiving system. The method can include a step of generating by a control unit control signals. The control signals can be used for controlling the receiving system and/or the sending system. The step of generating the control signals can include a step of generating the control signals based on user commands and/or based on the events received by the control unit.

The method can include a step of adding a time stamp to each of the events in order to allow to compare and/or replace predicted events with detected events occurring at the same time.

In a further aspect of the present invention a computer program product for operating a network system according to claim 1 or any embodiment of the network system is presented. The computer program product comprises program code means for causing the network system to carry out the method as defined in claim 12 or any embodiment of the method, when the computer program product is run on the network system.

In a further aspect a computer readable medium having stored the computer program product of claim 14 is presented. Alternatively or additionally, the computer readable medium can have the computer program product according to any embodiment of the computer program product stored.

It shall be understood that the network system of claim 1, the method of claim 12, the computer program product of claim 14, and the computer readable medium of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an embodiment of a network system in form of a connected lighting system;

FIG. 2 shows an embodiment of the method for operating the network system.

### DETAILED DESCRIPTION OF EMBODIMENTS

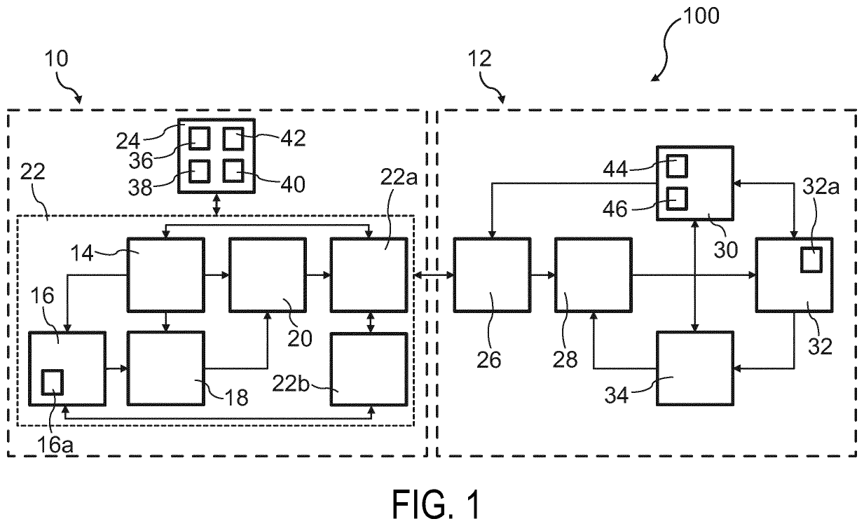

FIG. 1 shows schematically and exemplarily an embodiment of a network system in form of a CL system 100. The CL system 100 can for example be used for controlling the lighting in a building, such as a house or a factory. In other embodiments of the network system, the network system can also be a HVAC system, a building management system, a direct light control system, or a home automation system, such as a system with combined CL and HVAC functionality.

The CL system 100 comprises a sending system 10 and a receiving system 12. The sending system 10 performs the function of the CL system 100, in this case providing lighting, in particular providing lighting scenes in various rooms of a house. The receiving system 12 provides information to a user. In other embodiments the receiving system 12 can also be used for controlling the sending system 10. The CL system 100 can allow to reduce data traffic, cost and required communication bandwidth for sending events between the sending system 10 and the receiving system 12 as will be elucidated in the following.

The sending system 10 includes an event detector 14, a computer readable medium 16, a predictor 18, a comparer 20, a transceiver 22a, and a control unit 22b which are all integrated into a bridge 22 in this embodiment. Additionally the sending system 10 includes functional devices 24 which communicate with the bridge 22.

The receiving system 12 includes a transceiver 26, a replacer 28, a user interface 30, a computer readable medium 32, and a predictor 34.

The computer readable medium 16 includes a database 16a and the computer readable medium 32 includes a database 32a.

The event detector 14 detects changes in the sending system 10 as events. The transceivers 22a and 26 send and receive the events and other data, such as control signals. The databases 16a and 32a store data about the functional devices 24 of the sending system 10. The predictors 18 and 34 predict one or more events following one or more previous events in the sending system 10 and the receiving system 12 based on the one or more previous events and the data about the functional devices 24 stored in the databases 16a and 32a. The databases 16a and 32a are optional and in other embodiments the predictors can also predict the one or more events following the one or more previous events based on the one or more previous events without considering data about the functional devices 24 stored in the databases 16a and 32a. The comparer 20 compares one or more events detected by the event detector 14, i.e., one or more detected events, following the one or more previous events with the one or more predicted events predicted by the predictor 18 of the sending system 10. In case that no events are detected, but events are predicted, the predictions are incorrect. In this case the comparer 20 generates detected events that include no changes. Alternatively the comparer 20 can cause the control unit 22b to generate control signals which cause the replacer 28 to remove one or more predicted events. The transceiver 22a sends the one or more detected events to the receiving system 12 only, if the one or more detected events and the one or more predicted events predicted by the predictor 18 are not equal. Alternatively, if the control unit 22b generated control signals which cause the replacer 28 to remove one or more predicted events, the transceiver 22a sends the control signals to the receiving system 12 and the replacer 28 removes the one or more predicted events. If the one or more detected events are received by the transceiver 26 of the receiving system 12, the replacer 28 replaces the one or more predicted events predicted by the predictor 34 of the receiving system 12 with the one or more detected events and forwards the one or more detected events to the user interface 30, the database 32, and the predictor 34 for further processing. Else, the replacer 28 forwards the one or more predicted events to the user interface 30, the database 32, and the predictor 34 for further processing. In other embodiments the events can be send to external servers for further processing and processed information can be received from external servers.

Details of the embodiment of the CL system 100 are presented in the following. In other embodiments additional devices can be added or optional devices can be absent, e.g., the user interface may be absent.

The functional devices 24 in the sending system 10 include two luminaires 36 and 38, a switch 40, and a sensor 42. The functional devices 24 in this embodiment are arranged in a room. In other embodiments the sending system 10 can include further functional devices, such as additional luminaires, switches, sensors, or other types of functional devices, e.g., HVAC devices which can be arranged in different rooms.

The luminaires 36 and 38 provide light in dependence of their setting including color, color temperature, and brightness. The color can be adjusted by choosing different color values, such as in a red green blue (RGB) color model. The color temperature can be adjusted by changing a color temperature value in Kelvin. The brightness can be adjusted to a brightness level, also called dim level, e.g. in percent.

The switch 40 can communicate with the bridge 22 which activates or deactivates luminaires 36 and 38 and provides settings to the luminaires 36 and 38. The switch 40 includes an input unit that allows a user to interact with the switch 40 and to issue user commands. The bridge 22 can activate different lighting scenes in dependence of data about the functional devices 24, and the user commands. The data about the functional devices 24 includes data about a configuration of the functional devices 24 and data about the environment of the functional devices 24. For example, the bridge 22 can activate different lighting scenes in dependence of time of day when a user command is issued using switch 40. In other embodiments the switch may be replaced by a touch display or remote control that allows to directly activate and deactivate the luminaires and to adjust the color, color temperature, and brightness of the luminaires individually or collectively.

The sensor 42 in this embodiment is a motion and brightness sensor, i.e., detecting motions and measuring brightness. The sensor data can be provided to the bridge 22 which can deactivate or activate luminaires 36 and 38 in dependence of the sensor data. The sensor data can for example be analyzed by the event detector 14 and one or more events can be detected based on the sensor data.

The user interface 30 in the receiving system 12 includes a control unit 44 and an input unit in form of a touch display 46. The user can use the touch display 46 for interacting with the user interface 30. The control unit 44 generates user commands based on inputs of the user. The user commands can be send from the receiving system 12 to the sending system 10.

The control unit 22b of the bridge 22 generates control signals based on settings stored in the database 16a in form of data about the functional devices 24, e.g., activating or deactivating luminaires 36 and 38 at a certain time, and/or based on the received user commands. If no user commands are received, the control signals are automatically generated based on the received events or settings stored in the database 16a. For example, if it is 20:30 h and according to a setting stored in the database 16a, a certain luminaire has to be activated at that time, a respective control signal can be generated automatically by the control unit 22b. In another example, a motion is detected as event and in reaction the control unit 22b generates a control signal to activate the luminaire 36. The control unit 22b can queue tasks including repetitive tasks, as activating or deactivating a certain luminaire at a certain time each day.

In order to detect events, the event detector 14 receives the sensor data and information data from the functional devices 24. The event detector 14 analyses the sensor data and information data in order to determine an event. The sensor data and the information data can include information about the events. The sensor data can be provided from the sensor 42, e.g. including brightness measurements, detection of a motion, or any other sensor data, and the information data can be provided directly from each of the functional devices 24 to the event detector 14, e.g., reporting by a new functional device when it is added to the sending system 10. Alternatively or additionally, information data can also be provided from other sources, e.g., from the receiving system 12. Information data provided from other sources can for example include time information, weather information, or any other information that can be analyzed by the event detector 14 for detecting events.

The events inter alia include that a functional device is added to the sending system 10, that a functional device is replaced by another functional device, that a functional device is removed from the sending system 10, that a functional device is unreachable, that a functional device is deactivated, or that a functional device is activated, such as that one of the luminaires 36 and 38 is activated, that the switch 40 is switched, or that the sensor 42 is activated. The events can include activating a preconfigured setting for one or more of the functional devices 24, e.g., activating a lighting scene including color, color temperature, and/or brightness of one or both luminaires 36 and 38. In other embodiments with more luminaires, one or more of the luminaires can be activated and the color, color temperature, and brightness can be adjusted according to a preconfigured setting corresponding to a lighting scene. The events can further include changes in the environment of the sending system 10, e.g., sunrise, sunset, or any other change in brightness of the environment of the sending system, as well as changes in temperature or humidity in the environment of the sending system 10.

The databases 16a and 32a in this embodiment store identical data about the functional devices 24 of the sending system 10. Therefore, they are initialized with identical data about the functional devices 24 of the sending system 10 and provided with identical events. If an event is received by the databases 16a and 32a, they update the stored data about the functional devices 24 based on the event. The database 16a receives events from the event detector 14. The database 32a receives events from the replacer 28. The databases 16a and 32a can furthermore be synchronized, e.g., when the receiving system 12 is not connected to the sending system 10 for some time and the stored data about the functional devices 24 is not synchronized any more. Therefore, the data about the functional devices 24 of database 16a can be send from the sending system 10 to the receiving system 12 and the data about the functional devices 24 can be stored in database 32a.

The data about the functional devices 24 of the sending system 10 includes data about a configuration of the functional devices 24 of the sending system 10 and data about the environment of the functional devices 24 of the sending system 10.

The data about the configuration of the functional devices 24 include a position and number of the functional devices 24, i.e., in this embodiment four functional devices 24, of which two are the luminaires 36 and 38, one is the switch 40, and one is the sensor 42. The four functional devices 24 in this embodiment are all arranged in the same room and form a group of functional devices. In other embodiments additional groups can be formed, e.g., based on a hierarchical placement, such as in a room, a floor, a house area, or houses. Each functional device can be part of one or more groups, e.g., a functional device can be part of the group of a certain room, certain floor, certain house area, and certain house. The data about the configuration of the functional devices 24 furthermore include settings of the functional devices 24. In other embodiments the data about the configuration of the functional devices 24 can also include any other information about the configuration of the functional devices 24. In this embodiment the settings include brightness, color temperature, and color of the luminaires 36 and 38. The settings can include an information in which cases a respective setting is activated, e.g., a setting can be activated at a certain time and/or brightness.

The data about the environment of the functional devices 24 of the sending system 10 includes the geolocation, time information, and brightness information. In other embodiments the data about the environment of the functional device can also include any other information about the environment of the functional devices 24. The time information can for example be combined with the geolocation in order to determine a sunset time and a sunrise time at the location of the functional devices 24.

The databases 16a and 32a keep information about dynamically changing configurations of the functional devices 24 of the sending system 10. This allows to improve predictions, as the predictors 18 and 34 can base their predictions on the current configuration of the functional devices 24.

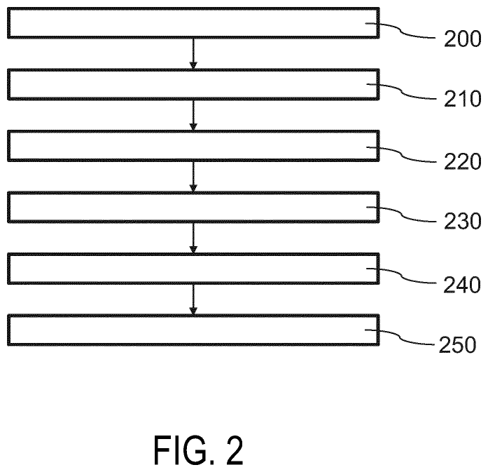

The computer readable media 16 and 32 furthermore store a computer program product for operating the CL system 100. The computer program product comprises program code means for causing the CL system 100 to carry out the steps of a method for operating the CL system 100, e.g. the method as presented in FIG. 2, when the computer program product is run on the CL system 100. In other embodiments the computer readable media 16 and 32 can store additional data.

The predictors 18 and 34 predict one or more events following one or more previous events based on the one or more previous events and the data about the functional devices 24 respectively stored in the database 16a and 32a. The predictors 18 and 34 predict different possible events based on one or more previous events and the data about the functional devices 24 stored in the databases 16a and 32a, i.e., taking into account the context of the one or more previous events. In this embodiment, the predictors 18 and 34 predict the one or more events by determining probabilities of the different events and by selecting the events with a probability above a threshold probability as the predicted events. The threshold probability in this embodiment is 50%. In other embodiments the threshold probability can also be 60%, 70%, 80%, or 90%. For example a previous event can be activating a lighting scene. The predicted events can then for example be activation of luminaire 36 with a respective color, color temperature, and brightness according to the lighting scene and activation of luminaire 38 with a respective color, color temperature, and brightness according to the lighting scene. The change of color, color temperature, and/or brightness can also be individual events, e.g., when a luminaire is already activated and a color, color temperature, or brightness is changed.

In other embodiments, the predictors can predict an event by determining probabilities of the different events and by selecting the event with the highest probability of the different events as the predicted event. In yet other embodiments, selection of the predicted event can depend on a combination of a probability threshold value and the selected event being the one with the highest probability, i.e., the event with the highest probability is only selected as predicted event, when its probability is above a threshold probability.

The predictors 18 and 34 can determine a probability of an event inter alia based on a reachability of one or more of the functional devices 24 of the sending system 10. The reachability of the functional devices 24 provide context for the event. The context can also for example be provided by the current configuration of the functional devices including the current position and number of luminaires, time information and/or brightness information, e.g., whether it is past sunset, and settings including lighting scenes. Hence, the predictors 18 and 34 can also determine the probability of an event based on the data about the functional devices 24. This allows the predictors to base their predictions on a dynamic configuration and lighting context information.

The events can include time stamps. The time stamps can be provided to the detected events by the event detector 14 and to the predicted events by the predictors 18 and 34. This allows the comparer 20 to compare predicted events with detected events occurring at the same time and the replacer 28 to replace predicted events with detected events occurring at the same time. The sending system 10 and the receiving system 12 can include clocks which can be time synchronized.

In summary, the bridge 22 can report events to an app running on the receiving system 12, e.g., a mobile phone or a cloud, i.e., a cloud server. All events are used by the predictor 18 and the comparer 20 in order to determine whether detected events are to be send by the bridge 22. The app running on the mobile phone or the cloud, performs an identical prediction and the replacer 28 replaces predicted events with detected events before they are further processed by the receiving system 12 if the predicted events and the detected event are not equal.

In other embodiments the sending system does not include a control unit. Instead the functions of the control unit of the sending system are performed by the control unit of the receiving system. The network system can be a building management system in this case in which the sending system and in particular the functional devices of the sending system are controlled by the receiving system. Therefore the control unit of the receiving system can generate control signals that can be provided to the functional devices.

In yet another embodiment no bridge is provided. The network system can be provided as a direct light control system in which the receiving system can be a remote control, e.g. a mobile phone. The mobile phone can be used to directly control the functional devices, e.g., activating the luminaires via a touch display of the mobile phone. The communication between the luminaires and the mobile phone can for example be based on a short-range communication protocol, such as Bluetooth. The sending system sends detected events to the mobile phone only if the predicted events and detected events are not equal. In this case the detection of the events can be directly performed at the functional devices. For example if the user sends control signals for activating a luminaire to the sending system, the predictors of the receiving system can predict that the luminaires are activated. The detected event that the luminaires are activated does not need to be send to the mobile phone from the sending system, as it will be correctly predicted by the predictors of the sending system, e.g., integrated in the functional devices, and the predictors of the mobile phone. In another example, when a luminaire is activated, normally multiple events are detected, e.g., individual events for reporting the lighting settings, including activation state of the luminaire, brightness level, color, and color temperature. As the predictors of the sending system and the mobile phone can use identical data about the lighting setting of the luminaire, they correctly predict the lighting setting of the luminaire when it is activated. This is possible as its previous lighting setting before activating the luminaire is known. Thus, only the event that the luminaire is activated has to be send to the mobile phone.

The direct light control system can include multiple receiving systems, e.g., in form of mobile phones or other remote controls connected to one or more of the functional devices of the sending system. The sending system can include multiple functional devices or each of the functional device can form an individual sending system. Multiple mobile phones can be connected to multiple luminaires of the sending system. The databases can store information about which mobile phones are connected to which functional devices of the sending system. Each of the receiving systems can be enabled to control some or all of the functional devices. If for example a mobile phone re-establishes a connection to a luminaire and in the meantime the activation state of the luminaire has changed, this can be provided as event to the mobile phone. The databases of the mobile phone and the sending system, e.g., integrated in the functional devices, can be updated accordingly in order to synchronize them for the functional devices the respective mobile phone is connected to. In a network system with multiple receiving systems, the sending system needs to keep track of the receiving systems connected to the sending system or functional devices of the sending system, as well as what information the receiving system have stored in their databases.

In the following, different scenarios for operating the CL system 100 or other embodiments of the network system are presented.

In a first scenario, predictors 18 and 34 can predict that the events following an activation of luminaire 36 with red color and 50% dim level is activating luminaire 38 with pink color and 70% dim level. The actually detected events are activating luminaire 38 with pink color and 70% dim level. The detected events do not need to be send from the sending system 10 to the receiving system 12 as the detected events are equal to the predicted events. As the predictors 18 and 34 predict the identical events in the sending system 10 and the receiving system 12, the predicted events corresponds to the detected events. This allows to reduce data traffic between the sending system 10 and the receiving system 12.

In a second scenario, the databases 16a and 32a store various lighting scenes for luminaires 36 and 38 in a room. If a lighting scene is selected using the user interface 30, the luminaires 36 and 38 are activated with certain colors, color temperatures, and brightnesses as event, e.g., various colors and color temperatures at various dim levels. If a luminaire is added or removed, this is provided as event to the databases 16a and 32a and the data about the functional devices 24 stored in the databases 16a and 32a is adapted accordingly. Hence, in the future the changed configuration of the luminaires is accounted for when one or more events are predicted.

In a third scenario, as a previous event one luminaire was activated which allows the predictors to predict the following events, e.g., activation of other luminaires, e.g., in the room, floor, and house.

In a fourth scenario, a sunset is detected as event and used to change the configuration of the functional devices 24 of the sending system 10. For example, the prediction of events following a previous event in which a motion is detected in a room can be changed from activating a luminaire with high brightness to activating the luminaire with low brightness in order to provide dimmed light. Day-light and sun-set times can be calculated based on the geolocation and time of the CL system 100.

In a fifth scenario, brightness measurements of a brightness sensor are detected as events and change the data about the configuration of the functional devices stored in the databases. If brightness is high enough, motion sensors will not cause a luminaire to be activated as it is bright enough in the room.

In a sixth scenario, a switch activating pattern of a user is determined, i.e., learned by the predictors. When one or more luminaires are activated using user commands, the predictors can predict the probability that one of the luminaire activating patterns stored in the databases is performed and respectively predict the events following this previous event, e.g., which luminaire will be activated next.

In a seventh scenario a motion is detected and transmitted as previous event to the receiving system. Furthermore as event, the user changes from one lighting scene to another lighting scene by issuing a user command in order to reduce brightness. The predictor of the receiving system can predict the event, e.g. switching from the one lighting scene to the other lighting scene by reducing the brightness. It is not required to send the detected event including the information about the reduced brightness. Instead it is sufficient to only send the event in which the motion is detected.

In an eighth scenario, an event of activating a luminaire based on a setting for activating the luminaire at a certain time is predicted, e.g., activating luminaire 36 at 20:30 h each day. This information can be stored in the database as predetermined setting. Hence, no transmission of the event is required. If the luminaire was reported to be not reachable in a previous event, the predicted event would be changed to not activated.

In a ninth scenario, the functional devices 24 can be wirelessly connected with the transceiver 22a of the bridge 22 and provide sensor data to the event detector 14. If a functional device is unreachable, no information from the functional device is received. This can be detected as event by the event detector 14, e.g., when a request for information is send to the functional device and no answer is received in return. This event can be provided to the databases 16a and 32a. The functional device may for example have lost connection, be broken, the battery can be empty, or it can be disconnected from its energy source. The reachability of the functional device can be used by the predictors 18 and 34 for determining a probability that a certain event will occur or not. If the probability of all possible events is below the threshold probability, no event will be predicted.

In a tenth scenario, an event is predicted but no event is detected. The predicted event is thus compared with no detected event in the comparer. The comparer in reaction generates a control signal that causes the replacer to remove the predicted event. The respective control signal is send to the receiving system in order to remove the predicted event. Alternatively the comparer can generate a detected event that includes no changes for replacing the predicted event. The incorrectly predicted event can be removed before it is further processed. This can for example be ensured by providing a small delay at the predictor of the receiving system compared to the predictor of the sending system.

FIG. 2 shows an embodiment of the method for operating a network system, e.g. the CL system 100 as presented in FIG. 1.

In step 200, the event detector detects one or more changes in the sending system as one or more events following one or more previous events.

In step 210 the predictors receive data about functional devices of the sending system. Step 210 is optional.

In step 220 the predictors predict one or more events following the one or more previous events based on the one or more previous events and the received data about the functional devices. Using the received data about the functional devices when predicting the one or more events is optional. The event can also be predicted based on the one or more previous events.

In step 230 the comparer compares the one or more events detected by the event detector to the one or more events predicted by the predictor of the sending system.

In step 240 the sending system sends the one or more detected events to the receiving system only if the one or more detected events and the one or more predicted events predicted by the predictor of the sending system are not equal.

In step 250 the replacer replaces the one or more predicted events predicted by the predictor of the receiving system with the one or more detected events if the one or more detected events are received by the receiving system.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein the network system is a HVAC system including one or more HVAC devices that includes one or more of the following devices: an air conditioning device, a heating device, a humidity control device, and/or a cooling device.

Other variations to the disclosed embodiments can be understood and effected by those skilled in the art in practicing the claimed invention, from a study of the drawings, the disclosure, and the appended claims.

In the claims, the words “comprising” and “including” do not exclude other elements or steps, and the indefinite article “a” or “an” does not exclude a plurality.

A single unit, processor, or device may fulfill the functions of several items recited in the claims. The mere fact that certain measures are recited in mutually different dependent claims does not indicate that a combination of these measures cannot be used to advantage.

Operations like detecting by the event detector one or more changes in the sending system as one or more events following one or more previous events, predicting by the predictors one or more events following the one or more previous events based on the one or more previous events, comparing by the comparer the one or more detected events to the one or more predicted events predicted by the predictor of the sending system, sending by the sending system the one or more detected events to the receiving system only if the one or more detected events and the one or more predicted events predicted by the predictor of the sending system are not equal, replacing by the replacer the one or more predicted events predicted by the predictor of the receiving system with the one or more detected events if the one or more detected events are received by the receiving system, receiving data about functional devices of the sending system by the predictors, predicting by the predictors one or more events following the one or more previous events based on the one or more previous events and the received data about the functional devices, et cetera performed by one or several units or devices can be performed by any other number of units or devices. These operations and/or the method can be implemented as program code means of a computer program and/or as dedicated hardware.

A computer program may be stored/distributed on a suitable medium, such as an optical storage medium, or a solid-state medium, supplied together with or as part of other hardware, but may also be distributed in other forms, such as via the Internet, Ethernet, or other wired or wireless telecommunication systems.

Any reference signs in the claims should not be construed as limiting the scope.

The present invention relates to reducing data traffic in network systems. An event representing a change in a sending system which follows a previous event is detected by an event detector. Furthermore an event following the previous event is predicted by predictors in the sending system and a receiving system based on the previous event. The detected and predicted event are compared by a comparer in the sending system. The detected event is send from the sending system to the receiving system only if the detected and predicted event are not equal. For ensuring use of correct events, the predicted event in the receiving system is replaced with the detected event if the detected event is received by the receiving system as in this case the prediction was not correct.

1. A network system comprising:
a sending system including an event detector configured for detecting changes in the sending system as events, and the sending system configured for sending at least some of the events to a receiving system, and
a receiving system for receiving said at least some of the events,
wherein the sending system and the receiving system each include a predictor for predicting one or more events following one or more previous events based on the one or more previous events,
wherein the sending system includes a comparer configured for comparing one or more events detected by the event detector following the one or more previous events with the one or more events predicted by the predictor of the sending system,
wherein the sending system is configured for sending the one or more detected events to the receiving system only if the one or more detected events and the one or more predicted events predicted by the predictor of the sending system are not equal, and
wherein the receiving system includes a replacer configured for replacing the one or more predicted events predicted by the predictor of the receiving system with the one or more detected events if the one or more detected events are received by the receiving system.

2. The network system according to claim 1, wherein the sending system and the receiving system each comprise a database for storing data about functional devices of the sending system,
wherein the predictor of the sending system is configured for predicting the one or more events based on the one or more previous events and the data about the functional devices stored in the database of the sending system, and
wherein the predictor of the receiving system is configured for predicting the one or more events based on the one or more previous events and the data about the functional devices stored in the database of the receiving system.

3. The network system according to claim 2, wherein both databases are configured for updating the stored data about the functional devices based on events received by the databases.

4. The network system according to claim 3, wherein the sending system is configured for providing detected events from the event detector to the database of the sending system and the receiving system is configured for providing identical events to the database of the receiving system such that both databases store the same information.

5. The network system according to claim 4, wherein the predictors are configured for predicting the one or more events by determining probabilities of different events and by selecting the events with a probability above a threshold probability as the predicted events or by selecting the event with the highest probability of the different events as the predicted event.

6. The network system according to claim 5, wherein the predictors are configured for determining a probability of an event based on a reachability of one or more functional devices of the sending system or wherein the predictors are configured for determining a probability of an event based on the data about the functional devices of the sending system.

7. The network system according to claim 1 comprising a user interface for allowing a user to interact with the network system and wherein the network system is configured for providing the user interface with the events.

8. The network system according to claim 1 comprising a control unit configured for controlling the sending system.

9. The network system according to claim 8, wherein the network system is a connected lighting system and the sending system includes at least one functional device including one or more of: a luminaire, a switch, and a sensor.

10. The network system according to claim 1, wherein the event detector is configured for detecting one or more events based on sensor data received from one or more functional devices of the sending system.

11. The network system according to claim 1, wherein the events include a time stamp in order to allow the comparer to compare predicted events with detected events occurring at the same time and in order to allow the replacer to replace predicted events with detected events occurring at the same time.

12. A method for operating the network system according to claim 1, comprising the steps:
detecting by the event detector one or more changes in the sending system as one or more events following one or more previous events,
predicting by the predictors one or more events following the one or more previous events based on the one or more previous events,
comparing by the comparer the one or more detected events to the one or more predicted events predicted by the predictor of the sending system,
sending the one or more detected events from the sending system to the receiving system only if the one or more detected events and the one or more predicted events predicted by the predictor of the sending system are not equal,
replacing by the replacer the one or more predicted events predicted by the predictor of the receiving system with the one or more detected events if the one or more detected events are received by the receiving system.

13. The method according to claim 12 further comprising the step:
receiving by the predictors data about functional devices of the sending system, and
wherein predicting by the predictors one or more events following the one or more previous events is performed based on the one or more previous events and the received data about the functional devices.

14. A non-transitory computer program product for operating the network system according to claim 1, wherein the computer program product comprises program code means for causing the network system to carry out the method as defined in claim 12, when the computer program product is run on the network system.

15. A non-transitory computer readable medium having stored the computer program product of claim 14.
